(19) United States
(12) Patent Application Publication
(10) Pub. No.: US 2008/0061686 A1
(43) Pub. Date: Mar. 13, 2008

(54) PHOSPHORESCENT LIGHT-EMITTING MATERIALS AND METHODS OF PREPARING

(76) Inventors: Jie Liu, Niskayuna, NY (US); Anil Raj Duggal, Niskayuna, NY (US); Qing Ye, Schenectady, NY (US); Kyle Erik Litz, Ballston Spa, NY (US)

Correspondence Address: GENERAL ELECTRIC CO.;GLOBAL PATENT OPERATION, 187 Danbury Road, Suite 204, Wilton, CT, 06897-4122, US

(21) Appl. No.: 11/687,057

(22) Filed: Mar. 16, 2007

Related U.S. Application Data
(60) Provisional application No. 60/784,749, filed on Mar. 22, 2006.

(51) Int. Cl. H01J 63/04; C08F 4/72; C08G 65/34; C09K 11/06

(52) U.S. Cl. 313/506; 252/301.16; 526/108; 528/425

(57) ABSTRACT

An organic composite comprising an electroactive material and an organic phosphorescent dye. The electroactive material and organic phosphorescent dye have been functionalized in order that when they are mixed together and a curing amount of radiation or heat is applied, the phosphorescent dye is covalently bonded to the crosslinked electroactive material. The method to prepare the organic composite is given. The invention is suitable for the mass production of any light management system. In one embodiment light emitting diodes are described.

### CROSS REFERENCE TO RELATED APPLICATIONS

The present application claims priority to U.S. Provisional Application No. 60/784,749, which was filed Mar. 22, 2006, herein incorporated by reference.

### BACKGROUND OF THE INVENTION

Organic electroluminescent material has many possible uses for commercial and consumer goods These goods hold the promise of more efficient uses of natural resources, and more technologically advanced devices and products. Possible utilitarian applications of organic electroluminescent material have been proposed for such diverse fields as, for example, electronics, automobile manufacturing, interior design. Particular applications have been suggested for use interior and exterior decoration, interior and exterior lighting, computer screens, stop lights and much more. Currently, experiments are being developed to minimize the expense and maximize the technical benefits of the technology to produce better and more useful products and devices.

Light management is an important use of the organic electroluminescent material technology. The light management applications and devices include a light-emitting layer that is activated by signal (such as in a light-emitting diode) or a layer of material that responds to radiant energy and generates a signal with or without an applied potential (such as detectors or voltaic cells). Examples of electronic devices that may respond to radiant energy are selected from photoconductive cells, photoresistors, photoswitches, phototransistors, and phototubes, and photovoltaic cells. An organic light-emitting device (OLED) is a thin component made of organic, semiconducting materials whose structure resembles that of an inorganic light-emitting diode. Organically driven displays function via organic electroluminescence, which is achieved by sandwiching an organic electroactive material doped with light emitting dyes between two electrodes. Recently there has been the utilization of several phosphorescent dopants that result in significantly more efficient OLED's. Phosphorescent dyes emit light for a longer period of time, because they are “trapped” in their excited state and cannot return to their ground state as easily. Phosphorescence may be preceded by a transition from a triplet excited state to an intermediate non-triplet state from which the emissive decay occurs. Phosphorescence from triplets can be enhanced over fluorescence by confining, preferably through bonding, the organic molecule in close proximity to an atom of high atomic number. Such a phosphorescent transition may be observed from an excited metal-to-ligand charge transfer (MLCT) state of an organometallic molecule such as tris(2-phenylpyridine)iridium(III). WO03/001616 discloses a light emitting material and an organic light emitting device, wherein the material has a light emitting mechanism based on transition from an excited triple state to a ground state and the material comprises a nonionic light emitting part which constitutes a part of the polymer.

A homogeneous dispersion of the dopant in phosphorescent dye doped polymer light management devices is an important factor determining the energy transfer processes and device performance. However, the most common methods of distributing the phosphorescent dopants in the organic polymer has been to disperse the dye in a random manner by vacuum vaporization process or to solubilize the organic polymer and dopant in a solvent. Phase separation resulting in a non-homogenous dispersion of the phosphorescent dye occurs over time. There remains a need for an improved method to disperse the phosphorescent dye in an organic polymer in a non-random, stable manner.

### SUMMARY OF THE INVENTION

An organic composite of the present invention comprises: (a) an electroactive material having at least one functional group selected from the group consisting of a vinyl, an acrylate, an epoxy, a hydroxyl, an allyl and combinations thereof; (b) an organic phosphorescent dye having functional groups selected from a vinyl, an acrylate, an epoxy, a hydroxyl, an allyl and combinations thereof, wherein the phosphorescent dye is covalently bound to the electroactive material. The phosphorescent dye may have at least one transition metal selected from the group consisting of iridium, platinum, osmium, rhenium and ruthenium. The electoractive material may be a crosslinkable composition of an epoxy, acrylate, or a combination of both. The composite material may also contain an organic initiator.

Another aspect of the presently described invention is a method of preparing an organic composite. The method comprises the steps of (a) providing an electroactive material having functional groups selected from the group consisting of a vinyl, an acrylate, an epoxy, a hydroxyl, an allyl and combinations thereof; (b) providing an organic phosphorescent dye having functional groups material having functional groups selected from the group consisting of a vinyl, an acrylate, an epoxy, a hydroxyl, an allyl and combinations thereof; (c) mixing the electroactive material with the organic phosphorescent dye to form a solution; (d) treating the solution of step (c) to covalently bond the organic phosphorescent dye component to the organic component. The process may also provide for the mixing of an organic initiator with the electroactive material and the phosphorescent dye. Additionally, either heat or radiation may be used to cure the organic composite.

In yet another embodiment of this invention, an organic electronic device is described. The device may comprise (a) a first electrode; (b) at least one organic charge transporting layer; (c) an organic composite; (d) a second electrode; wherein the organic composite comprises: i. an electroactive material having at least one functional group selected from the group consisting of vinyl, acrylate, epoxy, hydroxyl, allyl and combinations thereof; and ii. an organic phosphorescent dye having functional groups selected from a vinyl, an acrylate, an epoxy, a hydroxyl, an allyl and combinations thereof; wherein the phosphorescent light-emitting dye is covalently bound to the organic electroactive material. The device may have an organic phosphorescent dye containing at least one transition material; the transition metal may be iridium, platinum, osmium, rhenium and ruthenium. Further, the device of may also have a hole transport layer, an electron transport layer, other additional layers such as, abrasion resistant layer, or adhesion layers, a chemically resistant layers, a photoluminescent layers, a radiation-absorbing layers, a radiation reflective layers, a barrier layers, a planarizing layers, an optical diffusing layers, and combinations thereof. Additionally, the device may also have a base substrate selected from plastic, glass, metal and combinations thereof.

### DESCRIPTION OF FIGURES

FIG. 1 is a diagram that is representative of an embodiment according to the present disclosure.

FIG. 2 is a schematic representation of an exemplary embodiment according to the present disclosure.

FIG. 3 is a schematic representation of an exemplary embodiment according to the present disclosure.

FIG. 4 is a schematic representation of an exemplary embodiment according to the present disclosure.

FIG. 5 is a schematic representation of an exemplary embodiment according to the present disclosure.

FIG. 6 is a schematic representation of an exemplary embodiment according the present disclosure

FIG. 7 is a time resolved PL decay profiles of a 1 wt % Viny-1FIrpic polystyrene film sample prepared as described in Example 3 vs. a 1 wt % Vinyl-FIrpic:acrylate films ample prepared as described in Example 2

FIG. 8 is a PL Spectra of PVK:Vinyl-FIrpic:acrylate after rinsing with p-xylene and after soaking in p-xylene for 2 minutes. The sample was prepared according to the method described in Example 5.

FIG. 9 is a PL Spectra of PVK:FIrpic composite after rinsing with. The sample was prepared according to the method described in example 6.

FIG. 10 is a PL Spectra of PVK:FIrpic:acrylate The sample was prepared according to the method described in example 7.

### DETAILED DESCRIPTION OF THE INVENTION

Approximating language, as used herein throughout the specification and claims, may be applied to modify any quantitative representation that could permissibly vary without resulting in a change in the basic function to which it is related. Accordingly, a value modified by a term or terms, such as “about”, are not limited to the precise value specified. In at least some instances, the approximating language may correspond to the precision of an instrument for measuring the value. Range limitations may be combined and/or interchanged; such ranges are identified and include all the sub-ranges contained therein unless context or language indicates otherwise. Other than in the operating examples or where otherwise indicated, all numbers or expressions referring to quantities of ingredients, reaction conditions, and the like, used in the specification and claims are to be understood as modified in all instances by the term “about.” Various numerical ranges are disclosed in this patent application. Because these ranges are continuous, they include every value between the minimum and maximum values. Unless expressly indicated otherwise, the various numerical ranges specified in this application are approximations.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus.

“Electroactive material” refers to organic material which may be polymeric or non-polymeric, and which are susceptible to charge conduction when subjected to a voltage bias. Electroactive materials include, for example, organic semiconducting polymers. Those skilled in the art will appreciate that while electroluminescent materials represent a class of electroactive materials, a material need not be electroluminescent to be electroactive.

The electroactive material as described herein, is a wide bandgap organic material susceptible to charge conduction when subjected to a voltage bias. The wide bandgap organic material may have a triplet energy level greater than that of the phosphorescent dye. Included in the present disclosure are organic electroactive material that have cross linkable qualities, such as the acrylates, epoxy and siloxane polymers; insulating organic materials that have vinyl, hydroxyl and allyl functional groups; and other wide bandgap materials bearing available functional groups. As used herein, functional groups are specific groups of atoms within molecules that are responsible for the characteristic chemical reactions of those molecules. As described below, the electroactive material, comprised of crosslinkable electroactive materials have functional groups associated with them. The electroactive material may have functional groups that may be vinyl, acrylate, epoxy, hydroxyl, allyl and combinations thereof; although other functional moieties may be of use in the present invention.

The electroactive material may be adhesive-like materials (such as acrylate, epoxy, siloxane etc); insulating organic materials with functional groups such as vinyl groups, hydroxy groups and ally groups etc; wide bandgap materials with a triplet energy level greater than the dye of interest where the wide bandgap materials bearing functional groups such as vinyl groups; siloxanes, such as vinylsiloxanes or .SiH siloxanes.

Crosslinking initiation may involve the addition of an initiator compound either prior to or after deposition. In some embodiments of the invention, the crosslinking side-groups included in the polymer chains and/or initiator compounds may already have been blended with the polymer solution prior to deposition. A crosslinking, or curing, reaction is commenced by applying either ultra-violet radiation or heat, depending upon the properties of the deposited solution. In an embodiment of the invention, the deposited solution is UV-curable and hence, can be crosslinked by the application of ultra-violet. The chemistry and physics of cross-linking polymers and monomers with side groups and chains is well-known in the art. One example of a crosslinking initiator or agent is a magnesium cation (Mg²⁺) for UV crosslinking. In the case of thermal crosslinking, an organic diamine or other amine/amide can be used to crosslink together the functional HTL sulfonic acids (such as PSS). As is known in the art, certain co-polymer and other side-groups crosslink without the need for an additional initiating agent.

As used herein, the term “organic composite” is the combination of a phosphorescent dye chemically bonded to at least one electroactive material.

An “emissive dopant”, or “dye”, may emit via fluorescence (from singlet excited states), via phosphorescence (from triplet excited states) or both. An advantage of phosphorescence is that all of the excitons, which are formed either as a singlet or triplet excited state, may participate in luminescence. Useful phosphorescent materials are known in the art. The phosphorescent materials for use in the present invention are typically organo-metallic compounds. Useful organo-metallic compounds in the present invention include those that contain iridium complexes, platinum complexes, osmium complexes, ruthenium complexes, and other organo-metallic compounds as would be known to one skilled in the art. Cyclometallated iridium compounds, such as Iridium(III)bis[(4,6-difluorophenyl)-pyridinato-N,C²¹]picolinate (FIrpic) and iridium (tris-orthoiridated complex with 2-phenylpyridine (Ir(ppy)₃)), are well known phosphorescent dopants. Other representative iridium dyes that may be used by the present invention have been disclosed in, for example, co-pending U.S. patent application Ser. No. 11/506,001 and Ser. No. 11/504,552, herein incorporated by reference.

FIrpic, the cyclomettalated ligand of the following structure may also be used as the dye of the present invention:

[image]

As an example the FIrpic used in the invention may have one or more vinyl groups, one or more acrylolyl groups, one or more phenol groups or one or more allyl groups.

Another useful composition of dyes are the polymeric and polymerizable blue phosphorescent dyes having the formula Ir(RPPy)₂QR′₃X and represented by the following:

[image]

The formula Ir(RPPy)₂QR′₃X; wherein X is selected from the group consisting of a halogen, —CN, —CNS, —OCN, —SCN, -a thiosulfate, a sulfonyl halide, an azide or combinations thereof; R is selected from the group consisting of hydrogen, fluorine, or carbon trifluoride; Q is selected from the group consisting of nitrogen, phosphorous, arsenic, antimony or bismuth; R′ is selected from the group consisting of an alkyl group, an alkoxy group, aryl group, aryloxy group, or combinations thereof.

The term “alkyl” as used herein is intended to designate linear alkyl, branched alkyl, aralkyl, cycloalkyl, bicycloalkyl, tricycloalkyl and polycycloalkyl radicals comprising carbon and hydrogen atoms, and optionally containing atoms in addition to carbon and hydrogen. Alkyl groups may be saturated or unsaturated and may comprise, for example, vinyl or allyl.

As used herein the term “aliphatic radical” refers to an organic radical having a valence of at least one consisting of a linear or branched array of atoms that are not cyclic. Aliphatic radicals are defined to comprise at least one carbon atom. The array of atoms comprising the aliphatic radical may include heteroatoms such as nitrogen, sulfur, silicon, selenium and oxygen or may be composed exclusively of carbon and hydrogen. For convenience, the term “aliphatic radical” is defined herein to encompass, as part of the “linear or branched array of atoms which is not cyclic” a wide range of functional groups such as alkyl groups, alkenyl groups, alkynyl groups, haloalkyl groups, conjugated dienyl groups, alcohol groups, ether groups, aldehyde groups, ketone groups, carboxylic acid groups, acyl groups (for example carboxylic acid derivatives such as esters and amides), amine groups, nitro groups, and the like. As an example, the 4-methylpent-1-yl radical is a C₆ aliphatic radical comprising a methyl group, the methyl group being a functional group which is an alkyl group. Similarly, the 4-nitrobut-1-yl group is a C₄ aliphatic radical comprising a nitro group, the nitro group being a functional group. An aliphatic radical may be a haloalkyl group which comprises one or more halogen atoms which may be the same or different. Halogen atoms include, for example; fluorine, chlorine, bromine, and iodine. Aliphatic radicals comprising one or more halogen atoms include the alkyl halides trifluoromethyl, bromodifluoromethyl, chlorodifluoromethyl, hexafluoroisopropylidene, chloromethyl, difluorovinylidene, trichloromethyl, bromodichloromethyl, bromoethyl, 2-bromotrimethylene (e.g. —CH₂CHBrCH₂—), and the like. Further examples of aliphatic radicals include allyl, aminocarbonyl (i.e., —CONH₂), carbonyl, 2,2-dicyanoisopropylidene (i.e., —CH₂C(CN)₂CH₂—), methyl (i.e., —CH₃), methylene (i.e., —CH₂—), ethyl, ethylene, formyl (i.e. —CHO), hexyl, hexamethylene, hydroxymethyl (i.e.—CH₂OH), mercaptomethyl (i.e., —CH₂SH), methylthio (i.e., —SCH₃), methylthiomethyl (i.e., —CH₂SCH₃), methoxy, methoxycarbonyl (i.e., CH₃OCO—), nitromethyl (i.e., —CH₂NO₂), thiocarbonyl, trimethylsilyl (i.e.(CH₃)₃Si—), t-butyldimethylsilyl, 3-trimethyoxysilypropyl (i.e., (CH₃O)₃SiCH₂CH₂CH₂—), vinyl, vinylidene, and the like. By way of further example, a C₁-C₁₀ aliphatic radical contains at least one but no more than 10 carbon atoms. A methyl group (i.e., CH₃—) is an example of a C₁ aliphatic radical. A decyl group (i.e., CH₃(CH2)₉—) is an example of a C₁₀ aliphatic radical.

As used herein the term “cycloaliphatic radical” refers to a radical having a valence of at least one, and comprising an array of atoms which is cyclic but which is not aromatic. As defined herein a “cycloaliphatic radical” does not contain an aromatic group. A “cycloaliphatic radical” may comprise one or more noncyclic components. For example, a cyclohexylmethyl group (C₆H₁₁CH₂—) is an cycloaliphatic radical which comprises a cyclohexyl ring (the array of atoms which is cyclic but which is not aromatic) and a methylene group (the noncyclic component). The cycloaliphatic radical may include heteroatoms such as nitrogen, sulfur, selenium, silicon and oxygen, or may be composed exclusively of carbon and hydrogen. For convenience, the term “cycloaliphatic radical” is defined herein to encompass a wide range of functional groups such as alkyl groups, alkenyl groups, alkynyl groups, haloalkyl groups, conjugated dienyl groups, alcohol groups, ether groups, aldehyde groups, ketone groups, carboxylic acid groups, acyl groups (for example carboxylic acid derivatives such as esters and amides), amine groups, nitro groups, and the like. For example, the 4-methylcyclopent-1-yl radical is a C₆ cycloaliphatic radical comprising a methyl group, the methyl group being a functional group which is an alkyl group. Similarly, the 2-nitrocyclobut-1-yl radical is a C₄ cycloaliphatic radical comprising a nitro group, the nitro group being a functional group. A cycloaliphatic radical may comprise one or more halogen atoms which may be the same or different. Halogen atoms include, for example; fluorine, chlorine, bromine, and iodine. Cycloaliphatic radicals comprising one or more halogen atoms include 2-trifluoromethylcyclohex-1-yl, 4-bromodifluoromethylcyclooct-1-yl, 2-chlorodifluoromethylcyclohex-1-yl, hexafluoroisopropylidene-2,2-bis (cyclohex-4-yl) (i.e., —C₆H₁₀C(CF₃)₂ C₆H₁₀—), 2-chloromethylcyclohex-1-yl, 3-difluoromethylenecyclohex-1-yl, 4-trichloromethylcyclohex-1-yloxy, 4-bromodichloromethylcyclohex-1-ylthio, 2-bromoethylcyclopent-1-yl, 2-bromopropylcyclohex-1-yloxy (e.g. CH₃CHBrCH₂C₆H₁₀—), and the like. Further examples of cycloaliphatic radicals include 4-allyloxycyclohex-1-yl, 4-aminocyclohex-1-yl (i.e., H₂NC₆H₁₀—), 4-aminocarbonylcyclopent-1-yl (i.e., NH₂COC₅H₈—), 4-acetyloxycyclohex-1-yl, 2,2-dicyanoisopropylidenebis(cyclohex-4-yloxy) (i.e., —OC₆H₁₀C(CN)₂C₆H₁₀O—), 3-methylcyclohex-1-yl, methylenebis(cyclohex-4-yloxy) (i.e., —OC₆H₁₀CH₂C₆H₁₀O—), 1-ethylcyclobut-1-yl, cyclopropylethenyl, 3-formyl-2-terahydrofuranyl, 2-hexyl-5-tetrahydrofuranyl, hexamethylene-1,6-bis(cyclohex-4-yloxy) (i.e., —O C₆H₁₀(CH₂)₆C₆H₁₀O—), 4-hydroxymethylcyclohex-1-yl (i.e., 4-HOCH₂C₆H₁₀—), 4-mercaptomethylcyclohex-1-yl (i.e., 4-HSCH₂C₆H₁₀—), 4-methylthiocyclohex-1-yl (i.e., 4-CH₃SC₆H₁₀—), 4-methoxycyclohex-1-yl, 2-methoxycarbonylcyclohex-1-yloxy (2-CH₃OCOC₆H₁₀O—), 4-nitromethylcyclohex-1-yl (i.e., NO₂CH₂C₆H₁₀—), 3-trimethylsilylcyclohex-1-yl, 2-t-butyldimethylsilylcyclopent-1-yl, 4-trimethoxysilylethylcyclohex-1-yl (e.g. (CH₃O)₃SiCH₂CH₂C₆H₁₀—), 4-vinylcyclohexen-1-yl, vinylidenebis(cyclohexyl), and the like. The term “a C₃-C₁₀ cycloaliphatic radical” includes cycloaliphatic radicals containing at least three but no more than 10 carbon atoms. The cycloaliphatic radical 2-tetrahydrofuranyl (C₄H₇O—) represents a C₄ cycloaliphatic radical. The cyclohexylmethyl radical (C₆H₁₁CH₂—) represents a C₇ cycloaliphatic radical.

In general, organic phosphorescent dyes such as FIrpic in diluted solutions have higher photoluminescence quantum efficiency than in solid state films because of the self-quenching incurred in their solid-state films. For light-managing applications such as light-emitting devices, organic phosphorescent dyes are usually presented as a minor dopant material dispersed in an organic host. In order to maintain high phospholuminescence (PL) quantum efficiency of a phosphorescent dye, the corresponding host material should possess a triplet energy gap no smaller than that of the dye to prevent energy back transfer (a loss of PL quantum efficiency) from dye to the host and/or any impurities in contact with the dye.

In general, organic phosphorescent dyes such as FIrpic in diluted solutions have higher photoluminescence quantum efficiency than their pristine films because of self-quenching incurred in their solid-state films. For light-managing applications such as light-emitting devices, organic phosphorescent dyes are usually presented as a minor dopant material dispersed in an organic host. In order to maintain high PL quantum efficiency of a phosphorescent dye, the corresponding host material should possess a triplet energy gap no smaller than that of the dye to prevent energy back transfer (a loss of PL quantum efficiency) from dye to the host and/or any impurities in contact with the dye.

Triplet quenching experiments are conducted to evaluate whether or not the energy gap of a material is large enough (and/or the material is pure enough) to prevent energy back transfer from a dye dispersed in the material. For this purpose, insulating materials containing wide bandgaps, such as polystyrene (PS), are usually used as a reference. A dye dispersed in PS reflects its intrinsic photophysical properties such as PL quantum efficiency and a characteristic phosphorescent lifetime observed in diluted solutions. Time-resolved PL measurements record phosphorescent intensity over time; and comparison of such phosphorescent decay profiles of a dye dispersed in the material of interest relative to in PS provides direct information whether energy back transfer occurs.

The light management applications and devices of the present invention may be a light-emitting layer that is activated by signal (such as in a light-emitting diode) or a layer of material that responds to radiant energy and generates a signal with or without an applied potential (such as detectors or voltaic cells). Examples of electronic devices that may respond to radiant energy are selected from photoconductive cells, photoresistors, photoswitches, phototransistors, and phototubes, and photovoltaic cells. After reading this specification, skilled artisans will be capable of selecting material(s) that are suitable for their particular applications. The light-emitting materials may be dispersed in a matrix of another material, with or without additives, but preferably form a layer alone. In one embodiment, the organic composite is incorporated into an organic light-emitting device. In it's simplest form, an organic light-emitting device is comprised of an anode for hole injection, a cathode for electron injection, and an organic medium sandwiched between these electrodes to support charge recombination that yields emission of light. These devices are commonly referred to as organic light-emitting diodes, or OLEDs.

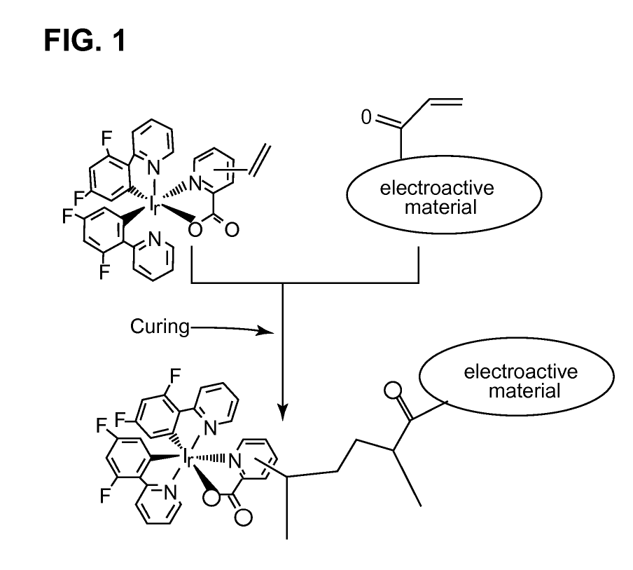

FIG. 1 demonstrates an embodiment of the present invention. According to this embodiment there is provided an organic composite capable of luminescence comprising an electoractive material comprising a polymer or oligomer; and an organic dye characterized in that the organic dye is covalently bound to the polymer or oligomer and the nature, location and/or proportion of the polymer or oligomer and of the organic dye in the material are selected so that the luminescence predominantly is phosphorescence. The covalent bond is formed after the functionalized electroactive material is mixed with the functionalized organic dye, and the solution is then cast and cured with a curing agent. The curing agent may be ultraviolet or heat radiation.

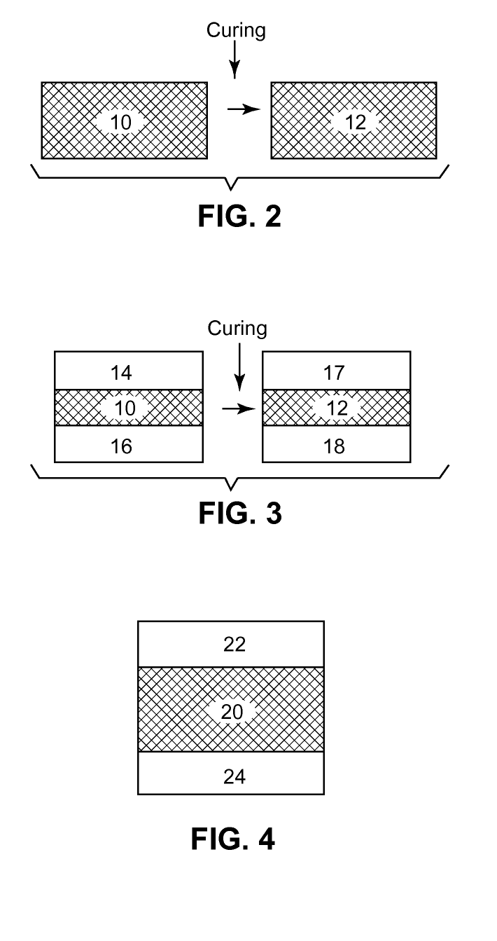

FIG. 2 demonstrates schematically another aspect of an embodiment of this invention. A mixture (10) of solutions of the functionalized dye and the functionalized electroactive material are mixed and subjected to a curing agent. The result (12) is a composite wherein the phosphorescent dye is covalently bound to the electroactive material.

In yet another embodiment of the present invention, as demonstrated in FIG. 3, the device is composed of at least three layers. This embodiment is formed by the curing of an upper layer (14) of a crosslinkable polymer, a middle layer (10) comprising a mixture of a functionalized electroactive material with a functionalized organic dye (16), and a third layer comprising (16) a crosslinkable polymer which may be the same or different than (14). Again the material is cured resulting in an covalently bound composite (12) surrounded by crosslinked polymer ((17) and (18)). In specific devices, utilizing appropriate materials and bonding in each of the layers of this embodiment, this multilayered structure facilitates charge injection and/or provide charge and exciton confinement that are critical to device efficiency.

Multilayered structures are usually preferred for some light-managing applications such as OLEDs. For instance, state-of-the-art phosphorescent OLEDs employ two or more extra layers in addition to the phosphorescent emissive layer. These extra layers usually consist of a hole-injection/transport layer, an electron-blocking layer, a hole-blocking layer and an electron-injection/transport layer. Multilayer structures can be easily realized in small molecular based OLEDs where all organic components are applied by dry vacuum processes such as thermal evaporation, sputtering etc. By contrast, building multilayered structures (such as for polymeric OLEDs) via wet-coating processes such as spin-casting is not trivial. The main challenge is that the solvent used in processing an organic layer may (partially) take off a pre-deposited underlying organic layer. Thus, to realize a multilayered structure via wet-coating processes materials used for adjacent layers should possess differential solubility. The composites described herein provide the desired differential solubility, thus enabling building multilayered OLEDs vis wet-coating processes. The wet-processed OLEDs provide advantages such as high throughput, low-cost manufacturing over their evaporated analogs. The electoractive material may be cast onto substrates using a variety of techniques well known to those skilled in the art. Typical casting techniques include, for example, solution casting, drop casting, curtain casting, spin-coating, screen-printing, inkjet printing, and the like.

Other devices that are suitable for preparation from this organic component, as a light management system would be known to one skilled in the art. Included among the possible devices are color (down)-converting (eg. absorb a portion of incident shorter wavelength light such as a blue light and emit at longer wavelength such as orange, creating a mixture of light such as white); interior/exterior decoration, interior and exterior lighting.

FIG. 4 schematically demonstrates an OLED embodiment of this application. In particular, an organic light emitting device comprising a organic composite comprising a functionalized electroactive material and a functionalized organic phosphorescent dye and at least one organic charge transport compositions bearing functional linking groups (20), the material has been cured and is crosslinked. In organic light emitting diodes (OLEDs), electrons and holes, injected from the cathode (22) and anode (24) layers, respectively, into the electroactive layer. A sufficient potential difference between the anode and cathode, usually less than approximately 12 volts, and in many instances no greater than approximately 5 volts, may be applied to the device. The actual potential difference may depend on the use of the device in a larger electronic component. In many embodiments, the anode layer is biased to a positive voltage and the cathode layer is at substantially ground potential or zero volts during the operation of the electronic device. A battery or other power source(s) may be electrically connected to the electronic device.

Non-limiting examples of organic charge transport materials include low- to intermediate molecular weight (for example, less than about 2000,000) organic molecules, poly (3,4-ethylenedioxythiophene) (PEDOT), polyaniline, poly (3,4-popylenedioxythiphene) (PProDOT), polystyrenesulfonate (PSS), polyvinayl carbazole (PVK), or like materials and combinations thereof. The hole transport layer materials may be functionalized with carbazole, amine, triarylamine groups and combinations thereof.

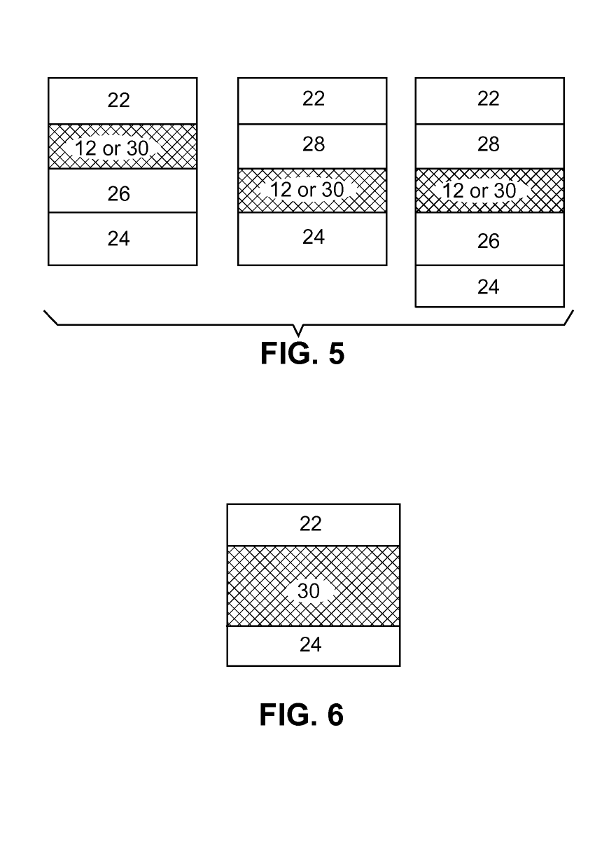

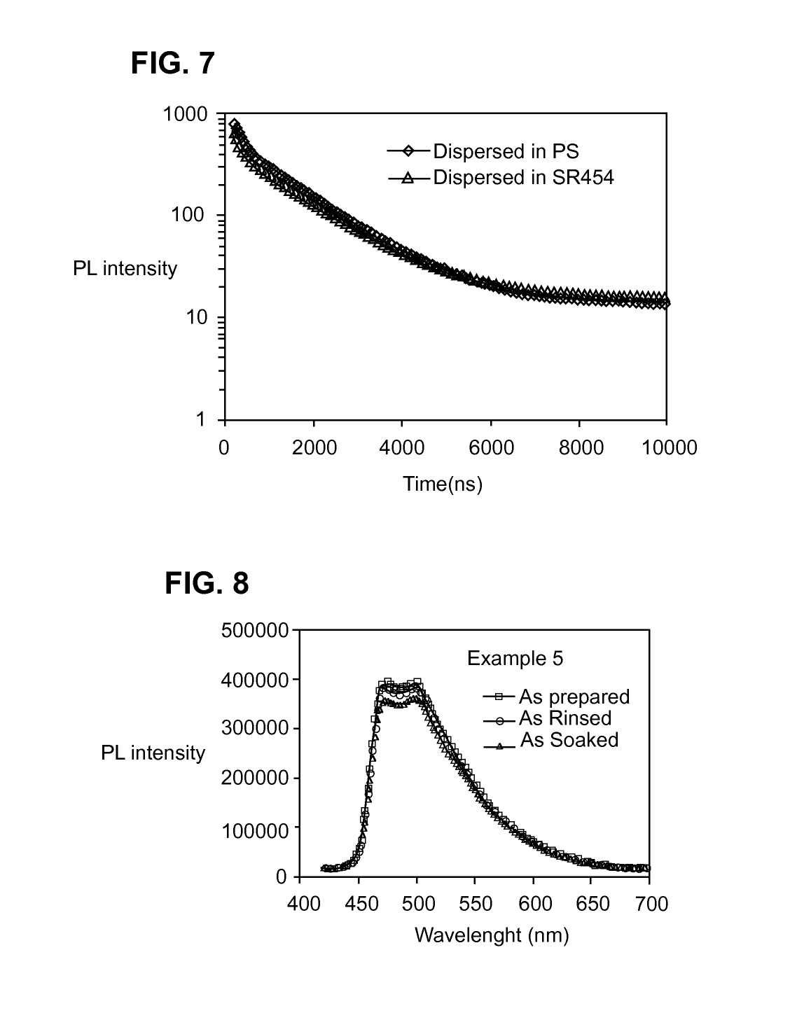

FIG. 5 demonstrates other embodiments of the invention schematically. An organic light emitting device may be comprised of a composite layer as described in FIG. 3 and FIG. 6 ((12) or (30)) an anode (24), a cathode (22), and a hole-injection layer (26), a electron injection layer (28), or a combination of both hole injection layers and electron-injection layers. As described below, other layers of suitable material may optionally be added to these embodiments to create light emitting diodes.

Alternatively, in yet a further embodiment (FIG. 6) of this invention an organic light emitting device comprising a organic composite layer (30) comprising an electroactive material covalently bound to an organic phosphorescent dye wherein the composite layer has hole transport and electron transport material noncovalently bound, but mixed therein.

The device may also contain a hole blocking layer comprising for example triazole and triazine base and the like. The electron-transport layers may be functionalized with fluorene, pyridine, phenylpyridine, triazole groups and combinations thereof. For example, suitable materials can be found in the art [for example, as described in M. Thelakkat and H. W. Schmidt, “Low molecular weight and polymeric heterocyclics as electron transport/hole-blocking materials in organic light-emitting diodes”, Polym. Adv. Technol., 9, 429-442 (1998)]. The device would also contain an anode and a cathode surrounding the organic composite.

Suitable anode materials for electroactive devices typically include those having a high work function value. Non-limiting examples of anode materials include, but are note limited to, indium tin oxide (ITO), tin oxide, indium oxide, zinc oxide, indium zinc oxide, nickel, gold, and like materials and mixtures thereof.

Suitable cathode materials for electroactive devices typically include materials having low work function value. Non-limiting examples of cathode materials include materials such as K, Li, Na, Mg, Ca, Sr, Ba, Al, Ag, Au, In, Sn, Zn, Zr, Sc, Y, Mn, Pb, elements of the lanthanide series, alloys thereof, particularly Ag—Mg alloy, Al—Li alloy, In—Mg alloy, Al—Ca alloy, and Li—Al-alloy and mixtures thereof. Other examples of cathode materials may include alkali metal fluorides, or alkaline earth fluorides, or mixtures of fluorides. Other cathode materials such as indiumtin oxide, tin oxide, indium oxide, zinc oxide, indium zinc oxide, zind indium tin oxide, antimony oxide, carbon naonotubes, and mixtures thereof. Alternatively, the cathode may be made of two layers to enhance electon injection. Non-limiting examples include, but are not limited to, an inner layer of either LaF or NaF followed by an outer layer of aluminum or silver, or an inner layer of calcium followed by an outer layer of aluminum or silver.

Organic light emitting devices of the present invention may include additional layers such as, but not limited to, one or more of an abrasion resistant layer, or adhesion layer, a chemically resistant layer, a photoluminescent layer, a radiation-absorbing layer, a radiation reflective layer, a barrier layer, a planarizing layer, an optical diffusing layer, and combinations thereof. The light emitting devices of the present invention may also include a base layer or a substrate layer. The substrate layer be selected any material that is effective in the device, for example glass, metal foils and plastics. In addition, the substrate layer may comprise other layers such as a smoothing layer, a prime layer and a backing layer, and mixtures thereof, that enhance the physical properties of the substrate, for example, the substrate's mechanical properties and/or the surface smoothness.

The different layers may have any suitable thickness. One skilled in the art would know how to choose the most suitable thickness of the layers for the various devices.

The invention will now be described in greater detail by reference to the following non-limiting examples.

### EXAMPLES

The following examples demonstrate the preparation and development of experimental derivatives that contain crosslinkable functionalities and devices prepared therefrom. The examples are not meant to limit the invention, and indeed, the examples illustrate and would make obvious other variations to one skilled in the art.

### Example 1

### Synthesis of (F₂ppy)₂Ir(3-Acryloylpicolinate) (Vinyl-FIrpic)

Step A. [(F₂ppy)₂Ir(3-hydroxypicolinate)] was prepared in the following manner. A 100 mL glass Wheaton vial was charged with sodium carbonate (2.4 g, 22.6 mmoles, Aldrich), 3-hydroxypicolinic acid (0.90 g, 6.5 mmoles, Aldrich), and [(F₂ppy)₂IrCl]₂ (2.5 g, 2.05 mmoles, American Dye Source) and then dissolved in 50 mL DMF (Aldrich). After addition of a 1 inch magnetic stir bar, the vial was sealed with a crimp cap and purged with nitrogen by syringe for 10 minutes. After letting the solution stir for another 10 minutes, the initially yellow color took on an orange hue whereupon it was placed into a pre-heated (85° C.) oil bath overnight. The orange reaction mixture was cooled to room temperature and poured into water (500 mL). The aqueous mixture was extracted (3×50 mL) with ethyl acetate and dried over sodium sulfate. After concentrating by rotary evaporation, the orange residue was dissolved in a minimum of chloroform and re-crystallized with hexane. The product was collected by filtration and dried in vacuo. Yield (2 g, 68%). ¹H NMR (400 MHz, d₆-DMSO, 25° C.) δ 5.48 (dd, 1H), 5.66 (dd, 1H), 6.82 (m, 2H), 7.24 (d, 1H), 7.35 (t, 1H), 7.5 (m, 1H), 7.62 (d, 1H), 7.7 (d, 1H), 7.96 (s, 1H), 8.09 (m, 2H), 8.23 (m, 2H), 8.5 (d, 1H), 13.56 (s, 1H). 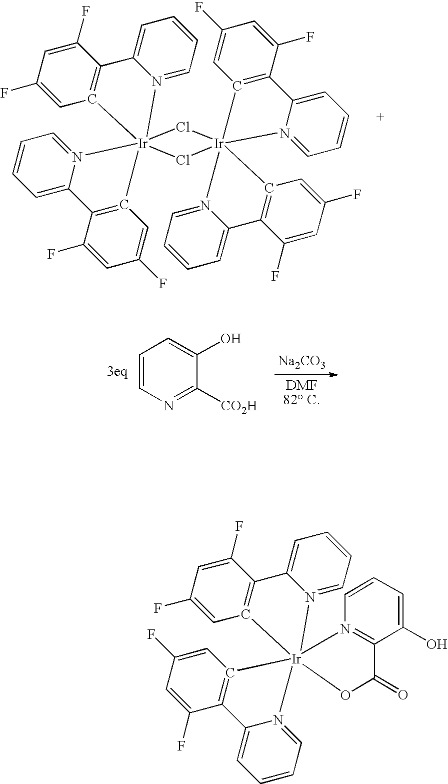
Step B. [(F₂ppy)₂Ir(3-acryloylpicolinate) Vinyl-FIrpic] was prepared as follows. A 20 mL glass Wheaton vial was charged with [(F₂ppy)₂Ir(3-hydroxypicolinate)] (0.25 g, 0.35 mmoles) and then dissolved in 10 mL chloroform (Aldrich). After addition of a ½ inch magnetic stir bar, acryloyl chloride (200 mg, 2.2 mmoles) and 0.5 mL of triethylamine (3.6 mmoles) were added by pipette. The vial was sealed with a crimp and stirred overnight at room temperature. The orange reaction mixture was concentrated and purified by flash chromatography (silica gel, gradient elution, chloroform:methanol 97:3 ratio). The product fraction was concentrated, taken up in minimum of chloroform and re-crystallized from hexanes. The yellow crystalline product was collected by filtration and dried in vacuo. Yield (144 mg, 54%). ¹H NMR (400 MHz, d₆-DMSO, 25° C.) δ 5.44 (dd, 1H), 5.68 (dd, 1H), 6.18 (d, 1H), 6.39-6.54 (m, 2H), 6.8-6.9 (m, 2H), 7.35 (t, 1H), 7.52 (t, 1H), 7.65-7.77 (m, 3H), 8.0-8.11 (m, 3H), 8.28 (m, 2H), 8.50 (d, 1H).

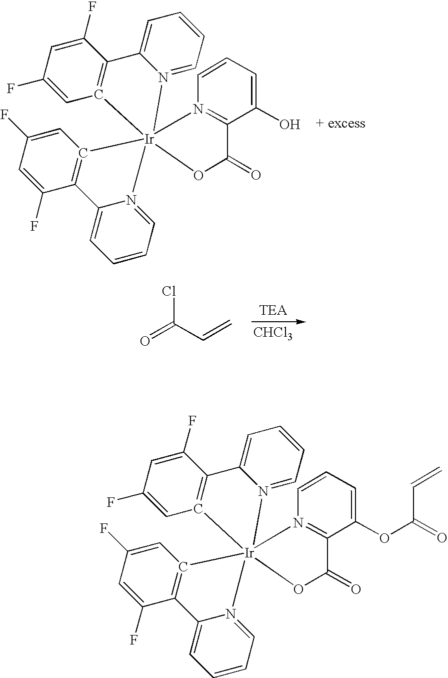

### Example 2

### Synthesis of Acrylate Conjugated Vinyl-FIrpic Film

8 mg of Vinyl-FIrpic (as prepared by the method of Example 1 was dissolved in 1.6 ml tetrahydrofuran (THF) to form a 0.5 wt % solution of FIrpic. 33 mg of an acrylate (ethoxylated trimethlopropane triacrylate) (SR454, purchased from Sartomer Company, Inc, 502 Thomas Jones Way, Exton, Pa. 19341, U.S.A.) was dissolved in 3.3 ml tetrohydrofuran (THF) to form a 1 wt % acrylate solution. Then 0.020 ml of the 0.5 wt % Vinyl-FIrpic in THF solution was mixed with 1.0 ml of 1 wt % acrylate in THF solution. The mixture solution was then drop-cast onto a quartz substrate and ultraviolet (UV) cured for one minute and baked at 110° C. for five minutes. Time resolved PL measurement was conducted on the film.

### Example 3

### Comparative Sample 1

A film was prepared in the same way as Example 2 except that polystyrene (PS) was used as the electroactive material in place of the acrylate (SR454).

### Example 4

### Triplet Quenching Experiments (Time-Resolved Phospholuminescence (PL) Measurements)

The time-resolved PL measurements were conducted using an Edinburgh CD920 spectrometer equipped with a cooled R928 photo multiplier tube. A sample was placed in a vacuum dewer and then pumped down to 4*10 E⁻⁵ torr. Then the sample was optically excited at 394 nm with a pulsed diode laser (pulse width 55 ps, repetition rate 10-40 kHz, 1-50 nJ per pulse). Time resolved emission spectra were measured at 470 nm.

Time resolved PL decay profiles of the Example 2 and the Comparative Example 3 are shown in FIG. 1. FIG. 1 demonstrates the similarity of the PL decay profiles, indicating that the composite sample has photoluminescence efficiency comparable to the comparative sample and there is no measurable energy back transfer (loss) from FIrpic to the host material (PS or SR454).

### Example 5

### Preparation of a (PVK:Vinyl-FIrpic:Acrylate) Composition

A solution of poly(9-vinylcarbazole) (PVK) was prepared by dissolving 44 mg of PVK (average Mw˜1,100,000), Aldrich) in 2.2 ml of tetrohydrofuran (THF) to form a 2 wt % solution. A 0.5 wt % Vinyl-FIrpic solution was prepared by dissolving 8 mg of Vinyl-FIrpic (as prepared by the method of example 1) in 1.6 ml THF. A 1.0 wt % acrylate solution was prepared by dissolving 33 mg of SR454 in 3.3 ml THF.

A mixture solution (PVK:Vinyl-FIrpic:Acrylate=70:10:20) was prepared by mixing 1.75 ml of the 2 wt % PVK solution, 1.0 ml of the 0.5 wt % Vinyl-FIrpic solution and 1.0 ml of the 1 wt % acrylate solution. The PVK:Vinyl-FIrpic:Acrylate solution was then drop-cast onto a quartz substrate and ultraviolet cured for one minute and baked at 110° C. for five minutes.

### Example 6

### Comparative Sample Preparation of (PVK:FIrpic) Composition

FIrpic without any functional groups was used to construct a comparative sample (PVK:FIrpic). A mixture solution of (PVK:FIrpic=90:10) was prepared by mixing 0.9 ml of 1.0 wt % PVK solution in THF with 0.10 ml of 1.0 wt % FIrpic solution in THF. The PVK:FIrpic solution was then drop-cast onto a quartz substrate and ultraviolet cured for one minute and baked at 110° C. for five minutes.

### Example 7

### Comparative Sample Preparation of (PVK:FIrpic:Acrylate) Composition

FIrpic without any functional groups was used to construct a comparative sample (PVK:FIrpic:Acrylate). A mixture solution (PVK:FIrpic:Acrylate=70:10:20) was prepared by mixing 0.7 ml of the 2 wt % PVK solution, 0.10 ml of the 1.0 wt % FIrpic solution and 0.20 ml of the 1 wt % SR454 (acrylate) solution in THF. The PVK:FIrpic:Acrylate solution was then drop-cast onto a quartz substrate and ultraviolet cured for one minute and baked at 110° C. for five minutes.

### Example 8

### Solvent Resistance Test

Samples prepared as in example 5, example 6 and example 7 were evaluated for dye retention. PL spectra of these samples were measured before and after rinsing with p-xylene. PL measurements were conducted using an Edinburgh CD920 spectrometer equipped with a cooled R928 photo multiplier tube. A sample was placed in a vacuum dewer and then pumped down to 4*10 E⁻⁵ torr. Then the sample was optically excited at 370 nm with a Xeon lamp and emission was recorded from 400 nm to 600 nm. P-xylene was chosen as the solvent because it is known to dissolve the dye molecules but not the PVK polymers. In addition, samples were excited at 370 nm, a wavelength where only dye molecules, not the PVK polymers, absorb. Under the conditions used, the PL intensity of such a film correlates with the amount of dye molecules dispersed in the film and therefore the change in PL intensity relates to the amount of dye molecules in the film after rinsing with p-xylene. General experimentation procedures are shown as follow:
1) load a sample into the spectrometer;
2) measure the first PL spectrum of the sample as prepared;
3) unload the sample from the spectrometer;
4) rinse the sample with p-xylene by flooding the sample surface with p-xylene and spinning for 30 seconds with a spin-coater;
5) reload the sample into the spectrometer
6) measure the second PL spectrum of the sample as rinsed;
7) unload the sample from the spectrometer;
8) (optional) soak the sample with p-xylene by flooding the surface with p-xylene and spinning for 30 seconds after 2-minute dwell time with a spin-coater;
9) (optional) reload the sample into the spectrometer;
10) (optional) measure the third PL spectrum of the sample as soaked

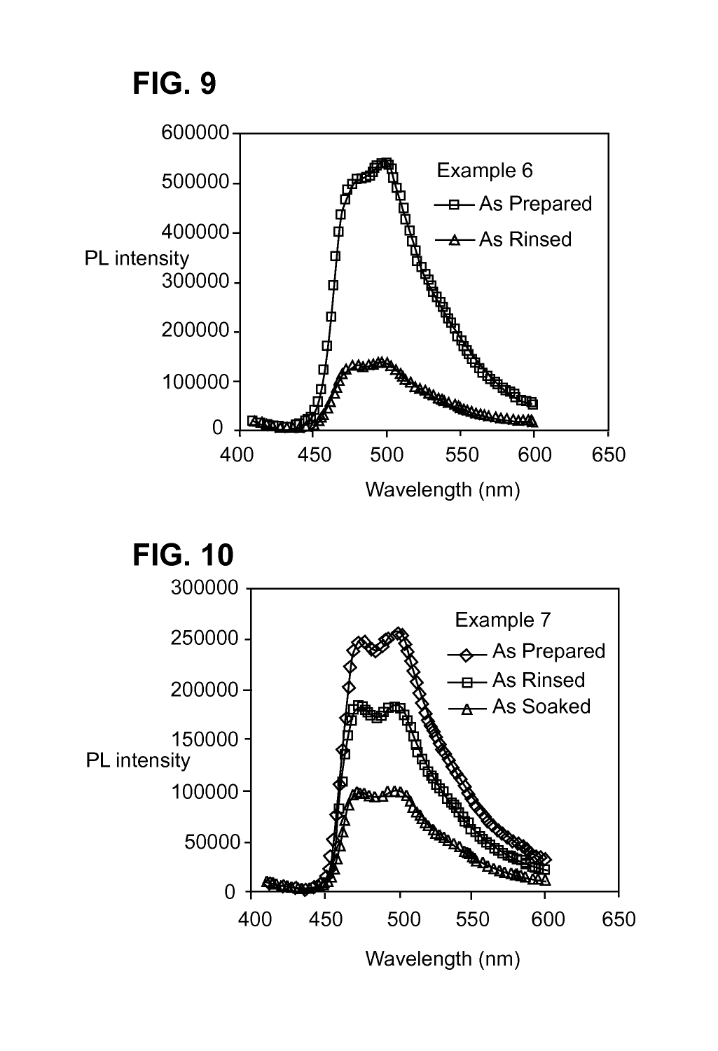

FIG. 8 compares PL spectra of a sample as prepared according to the method described in Example 5. The sample was measured after all of the ten steps as described above. Rinsing with p-xylene as well as soaking in p-xylene did not cause significant change in PL intensity, indicating good retention of dye molecules as dye molecules (Vinyl-FIrpic), which were chemically bonded to the cured acrylate component (SR454). By contrast, rinsing the comparative sample as prepared according to the method described in Example 6 (PVK:FIrpic) without the acrylate component (SR454) resulted in a significant reduction in PL intensity [see FIG. 9] because some FIrpic molecules are washed off by p-xylene. Similar reduction in PL intensity was also observed with the comparative sample as prepared according to the method described in Example 7 that employs FIrpic without any functional groups. FIG. 10, demonstrates the lack of interaction of FIrpic molecules with the acrylate component (SR454). These results demonstrate an anchoring of the dye molecules in solid films.

### Example 9

### Synthesis of 9-(Allyl Ethyl Ether)

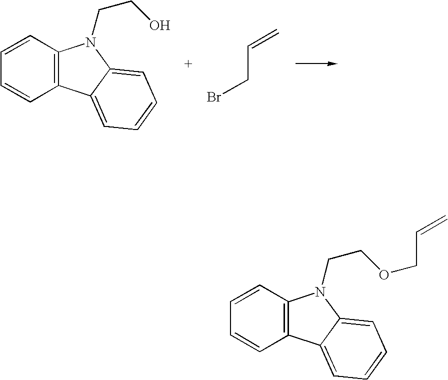 To a solution of the N-hydroxyethylcarbazole (10.56 mg, 50 mmol ) [Aldrich] in THF (50 mL) were added NaH (4.8 g, 200 mmol). After stirring at room temperature for 30 min, allyl bromide (12 g, 0.1 mmol) was added at room temperature. The mixture was stirred for 24 hours, then was poured into water, and then extracted with ethyl acetate (20 mL). The extract was washed with water (20 mL×2) and brine (20 mL×1), dried over Mg₂SO₄, and concentrated to dryness. The resulting residue was further purified through silica gel to give product as a colorless oil. Yield (12 g, 95%). ¹H NMR (400 MHz, CDCl₃) δ 8.16 (d, 2H), 7.53 (m, 4H), 5.86 (m, 1H), 5.22(dt, 1H), 5.17 (dd, 1H), 4.55 (t, 2H), 3.96 (dt, 2H), 3.87 (t, 2H)

### Example 10

### Vinyl-Terpyridine

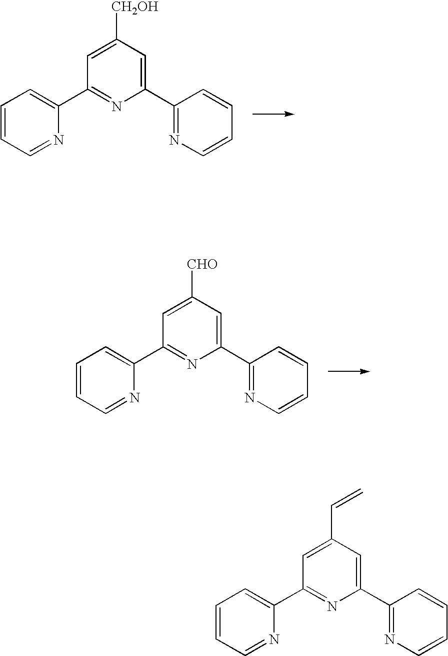 Step A—terpyridine aldehyde: A solution of oxalyl chloride (0.45 g, 3.56 mmol) [Aldrich] in CH₂Cl₂ (20 mL) at −78° C. was added under N₂ a solution of dimethyl sulfoxide (DMSO) (0.61 g, 5.88 mmol) in CH₂Cl₂ (2 mL). After 10 min a solution of terpyridine alcohol (0.648 g, 2.46 mmol), (prepared according the procedure described in J. Inorg. Chem. 2000, 741) in 7 mL of CH₂Cl₂ was added. The mixture was stirred for 15 min and 1.64 g of tetraethylammonium (TEA) was added. The cooling bath was removed and water (40 mL) was added at room temperature. The aqueous phase was extracted with CH₂Cl₂ (30 mL×3). The combined organic phase was dried and removed. 0.65 g of crude product was collected and recrystallization from acetone afforded 0.4 g of pure product and used in the next step. ¹H (CDCl₃) δ 10.30 (s, 1H), 8.91 (s, 1H), 8.78 (d, 2H), 8.66 (d, 2H), 7.93 (td, 2H), 7.43 (dd, 1H), 7.43 (dd, 1H).

Step B—Vinyl-Terpyridine: To a solution of methyltriphenylphosphonium bromide (1.07 g, 2.996 mmol) in dry THF at 0° C. was added drop wise 1.6 M n-BuLi solution in hexane (1.87 ml, 2.996 mmol). The solution was stirred at 0° C. for 1 hour and then was warmed to room temperature. A solution of terpyridine aldehyde (0.55 g, 2.14 mmol) in 20 mL of THF was added. The solution was stirred overnight and aldehyde was disappeared. Solution was concentrated to remove THF. Then CH₂Cl₂ (20 mL) and water (20 mL) was added to re-dissolve the mixture and separated. The organic layer was further washed with water (20 mL×2) and brine solution (20 mL) then was dried with MgSO₄. Solvent was removed in vacuo. After column chromatography on neutral alumina column using EtOAc as eluting solvent afforded 0.2 g of product. ¹H (CDCl₃) δ 8.75 (d, 2H), 8.66 (d, 2H), 8.52 (s, 2H), 7.91(td, 2H), 7.39 (dd, 2H), 6.90 (dd, 1H), 6.27(d, 1H), 5.61(d, 1H).

### Example 11

### [(F₂ppy)₂Ir(5-Hydroxypicolinate)]

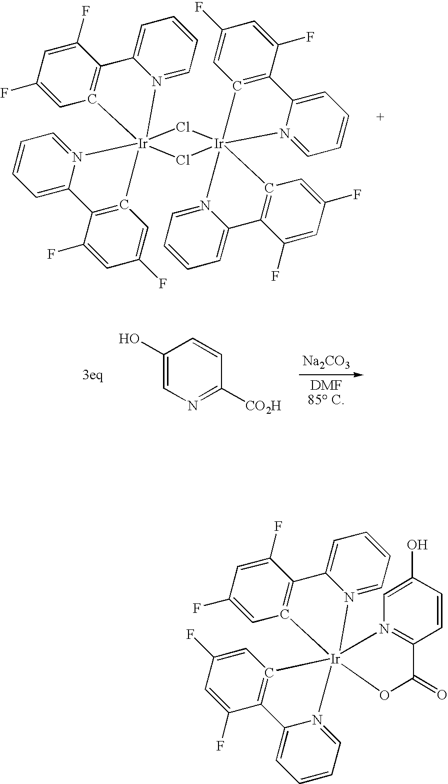 A 100 mL glass Wheaton vial was charged with sodium carbonate (2.4 g, 22.6 mmoles, Aldrich), 5-hydroxypicolinic acid (0.96 g, 6.9 mmoles, Synchem Ltd), and [(F₂ppy)₂IrCl]₂ (2.72 g, 2.2 mmoles, American Dye Source) and then dissolved in 50 mL DMF (Aldrich). After the addition of a 1-inch magnetic stir bar, the vial was sealed with a crimp cap and purged with nitrogen by syringe for 10 minutes. After stirring the solution for another 10 minutes, the initially yellow color took on an orange hue whereupon it was placed into a pre-heated (85° C.) oil bath overnight. The orange reaction mixture was cooled to room temperature and poured into water (500 mL) causing some of the product to precipitate. The solids were collected by filtration and set aside. The aqueous fraction was extracted with chloroform, dried over sodium sulfate, and concentrated. The concentrate and initial solid precipitate were combined and dissolved in a minimum of chloroform and then re-crystallized with hexane. The yellow crystalline product was collected by filtration and dried in vacuo. Yield (2.17 g, 68%). ¹H NMR (400 MHz, d₆-DMSO, 25° C.) δ 5.47 (dd, 1H), 5.69 (d, 1H), 6.8 (m, 2H), 7.23 (d, 1H), 7.34 (t, 1H) 7.42 (dd, 1H), 7.5 (t, 1H), 7.68 (d, 1H), 7.95 (s, 1H), 8.04 (m, 2H), 8.26 (t, 2H), 8.54 (d, 1H), 11.1 (s, 1H).

### Example 12

### FIrpic with Different Linking Groups

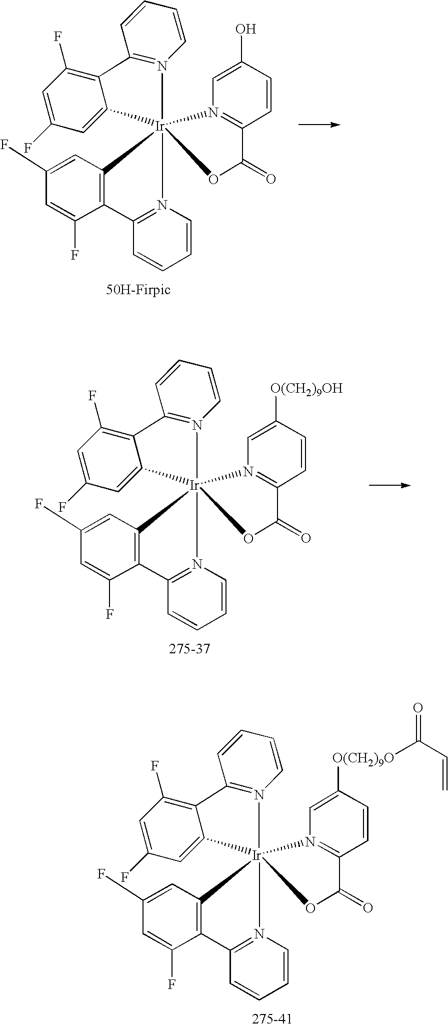 0.37 g of [(F₂ppy)₂Ir (5-hydroxypicolinate)] as prepared in Example 11) and 0.4 g of K₂CO₃ was added together into 20 mL of DMF in a 3 neck round bottomed flask equipped with a dean-stark trap. 3 mL of toluene was added and the reaction was heated to 120° C. to remove water. After all the toluene was removed, 0.5 g of 1-bromo-nonanol (Br(CH₂)₉OH) was added, along with 0.1 g of tetrabutyl ammonium iodide. The reaction mixture was kept at 120° C. for 12 hours. After cooling to room temperature, ethylacetate (30 mL) and water (30 mL) was added. The organic and aqueous phase were separated and the organic phase was further extracted with water (30 mL×2) and brine (30 mL×1). The resulting solution was dried over MgSO₄ and the solvent removed in vacuo. Column chromatography on silica gel using CH₂Cl₂/MeOH as eluting solvent afforded 0.2 84 g of viscous solid as product. ¹H (CDCl₃) δ 8.75 (s, 1H), 8.26 (m, 3H), 7.78 (s, 2H), 7.47 (d, 1H), 7.37 (d, 1H), 7.36 (s, 1H), 7.20 (t, 1H), 7.00 (t, 1H), 6.49 (t, 1H), 6.39 (t, 1H), 5.83 (d, 1H), 5.56 (d, 1H), 3.89 (t, 2H), 3.63 (t, 2H), 1.73 (t, 2H), 1.56 (t, 2H), 1.30 (broad peak, 10H).

Having thus described the invention in detail, it is to be understood that the foregoing description is not intended to limit the spirit and scope thereof.

What is desired to be protected by Letters Patent is set forth in the appended claims:

1. An organic composite comprising:
(a) an electroactive material having at least one functional group selected from the group consisting of a vinyl, an acrylate, an epoxy, a hydroxyl, an allyl and combinations thereof;
(b) an organic phosphorescent dye having functional groups selected from a vinyl, an acrylate, an epoxy, a hydroxyl, an allyl and combinations thereof;
wherein the phosphorescent dye is covalently bound to the electroactive material.

2. The composite of claim 1 wherein the organic phosphorescent dye has at least one transition metal selected from the group consisting of iridium, platinum, osmium, rhenium and ruthenium.

3. The composite of claim 1 wherein electroactive material is a crosslinkable composition of an epoxy, an acrylate or a combination thereof.

4. The composite of claim 1 wherein the electroactive material has two or more functional groups.

5. The composite of claim 1 further comprising an organic initiator.

6. A method of preparing an organic composite comprising
(a) providing an electroactive material having functional groups selected from the group consisting of a vinyl, an acrylate, an epoxy, a hydroxyl, an allyl and combinations thereof;
(b) providing an organic phosphorescent dye having functional groups material having functional groups selected from the group consisting of a vinyl, an acrylate, an epoxy, a hydroxyl, an allyl and combinations thereof;
(c) mixing the electroactive material with the organic phosphorescent dye to form a solution;
(d) treating the solution of step (c) to covalently bond the organic phosphorescent dye component to the organic component.

7. The process of claim 6 further comprising the step of adding at least one organic initiator into the solution of step (c).

8. The process of claim 6 wherein the solution of step (c) is treated with heat or radiation to covalently bond the organic phosphorescent dye to the electroactive material.

9. The process of claim 6 wherein the organic phosphorescent dye comprising at least one transition metal selected from the group consisting of iridium, platinum, osmium, rhenium and ruthenium.

10. The process of claim 6 wherein the electroactive material is an epoxy, an acrylate or a combination thereof.

11. The process of claim 6 wherein the electroactive material has two or more functional groups.

12. An organic electronic device comprising:
(a) a first electrode;
(b) at least one organic charge transporting layer;
(c) an organic composite;
(d) a second electrode;
wherein the organic composite comprises:
i. an electroactive material having at least one functional group selected from the group consisting of vinyl, acrylate, epoxy, hydroxyl, allyl and combinations thereof;
ii. an organic phosphorescent dye having functional groups selected from a vinyl, an acrylate, an epoxy, a hydroxyl, an allyl and combinations thereof;
wherein the phosphorescent light-emitting dye is covalently bound to the organic electroactive material.

13. The device of claim 12 wherein the organic phosphorescent dye has at least one transition metal selected from the group consisting of iridium, platinum, osmium, rhenium and ruthenium.

14. The device of claim 12 wherein the device further comprises a hole transport layer.

15. The device of claim 14 wherein the hole transport layer comprises an electroactive material having functional groups selected from group consisting of carbazole, amine, triarylamine and combinations of such.

16. The device of claim 12 wherein the device further comprises an electron transport layer.

17. The device of claim 16 wherein the electron transport layer comprises an electroactive material having functional groups selected from group consisting of fluorene, pyridine, phenylpyridine and combinations thereof.

18. The device of claim 12 wherein the electroactive material in the said organic composite has two or more functional groups.

19. The device of claim 18 further comprising a substrate selected from plastic, glass, metal and combinations thereof.

20. The device of claim 12 further comprising a layer selected from the group consisting of an abrasion resistant layer, an adhesion layer, a chemically resistant layer, a photoluminescent layer, a radiation-absorbing layer, a radiation reflective layer, a barrier layer, a planarizing layer, an optical diffusing layer and combinations thereof
